(19) United States
(12) Patent Application Publication
(10) Pub. No.: US 2026/0228576 A1
(43) Pub. Date: Aug. 6, 2026

(54) SYSTEM AND METHOD FOR DATA IMPUTATION

(71) Applicant: The Toronto-Dominion Bank, Toronto (CA)

(72) Inventors: Michael CRISTEA, Toronto (CA); Mahdi GHELICHI, Toronto (CA)

(73) Assignee: The Toronto-Dominion Bank, Toronto (CA)

(21) Appl. No.: 19/045,954

(22) Filed: Feb. 5, 2025

(51) Int. Cl. G06N 5/045

(52) U.S. Cl. CPC G06N 5/045

(57) ABSTRACT

A computer system comprises a communications module; at least one processor coupled with the communications module; and a memory coupled to the at least one processor and storing processor-executable instructions which, when executed by the at least one processor, configure the at least one processor to engage a trained artificial intelligence model to generate at least one prediction for a dataset; identify at least one feature in the dataset that requires imputation; determine feature values of the at least one feature that produced a neutral Shapley Additive exPlanation (SHAP) value; calculate a representative statistic from the determined feature values; and impute at least one missing data point within the at least one feature with the calculated representative statistic to create a modified dataset.

### TECHNICAL FIELD

The present application relates to systems and methods for data imputation.

### BACKGROUND

Data imputation is a technique employed to address missing values within datasets, aiming to enhance the predictive performance of artificial intelligence models. Traditional imputation methods such as mean, median or mode imputation fail to consider the contextual significance of missing values or the interdependencies among features within the dataset.

Some imputation methods handle missing data by excluding incomplete entries, which can introduce bias and degrade the accuracy of model predictions.

Other imputation methods involve training separate models specifically designed to manage datasets with missing values. Training separate models introduces additional development costs, increases system complexity, complicates validation, and amplifies the risk of error propagation.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence engine;

FIG. 4 shows, in flowchart form, an example method for data imputation;

FIG. 5 shows, in flowchart form, an example method for selecting an updated prediction as a final prediction;

FIG. 6 shows, in flowchart form, an example method for selecting a representative statistic for a final prediction; and

FIG. 7 shows, in flowchart form, an example method for generating a training dataset.

Like reference numerals are used in the drawings to denote like elements and features.

### DETAILED DESCRIPTION OF VARIOUS EMBODIMENTS

Accordingly, in one aspect there is provided a computer system comprising a communications module; at least one processor coupled with the communications module; and a memory coupled to the at least one processor and storing processor-executable instructions which, when executed by the at least one processor, configure the at least one processor to engage a trained artificial intelligence model to generate at least one prediction for a dataset; identify at least one feature in the dataset that requires imputation; determine feature values of the at least one feature that produced a neutral Shapley Additive exPlanation (SHAP) value; calculate a representative statistic from the determined feature values; and impute at least one missing data point within the at least one feature with the calculated representative statistic to create a modified dataset.

In one or more embodiments, the instructions, when executed by the at least one processor, further configure the at least one processor to generate SHAP values for features in the dataset based on the at least one prediction.

In one or more embodiments, the instructions, when executed by the at least one processor, further configure the at least one processor to engage the trained artificial intelligence model to generate at least one updated prediction for the modified dataset.

In one or more embodiments, the instructions, when executed by the at least one processor, further configure the at least one processor to calculate another representative statistic from the determined feature values; impute the at least one missing data point within the at least one feature with the calculated other representative statistic from the determined feature values to create another modified dataset; and engage the trained artificial intelligence model to generate at least one other updated prediction for the other modified dataset.

In one or more embodiments, the instructions, when executed by the at least one processor, further configure the at least one processor to generate SHAP values for features in the modified dataset based on the at least one updated prediction; generate SHAP values for features in the other modified dataset based on the at least one other updated prediction; and compare at least one of the SHAP values for features in the modified dataset based on the at least one updated prediction to the SHAP values for features in the other modified dataset based on the at least one other updated prediction or the at least one updated prediction for the modified dataset to the at least one other updated prediction for the other modified dataset to select one of the updated prediction or the other updated prediction as a final prediction.

In one or more embodiments, the instructions, when executed by the at least one processor, further configure the at least one processor to generate SHAP values for features in the modified dataset based on the at least one updated prediction; and compare at least one of the SHAP values for features in the dataset based on the at least one prediction to the SHAP values for features in the modified dataset based on the at least one updated prediction or the at least one prediction for the dataset to the at least one updated prediction for the modified dataset to select the updated prediction as a final prediction.

In one or more embodiments, the determined feature values include a range of feature values.

In one or more embodiments, the representative statistic includes at least one of a median of the determined feature values or a mode of the determined feature values.

In one or more embodiments, when identifying the at least one feature in the dataset that requires imputation, the instructions, when executed by the at least one processor, further configure the at least one processor to determine that the at least one feature includes a threshold number of missing feature values.

In one or more embodiments, the trained artificial intelligence model includes a tree-based artificial intelligence model.

In one or more embodiments, the neutral SHAP value includes a SHAP value that is within a threshold range of SHAP values.

According to another aspect there is provided a computer-implemented method comprising engaging a trained artificial intelligence model to generate at least one prediction for a dataset; identifying at least one feature in the dataset that requires imputation; determining feature values of the at least one feature that produced a neutral Shapley Additive exPlanation (SHAP) value; calculating a representative statistic from the determined feature values; and imputing at least one missing data point within the at least one feature with the calculated representative statistic to create a modified dataset.

In one or more embodiments, the method further comprises engaging the trained artificial intelligence model to generate at least one updated prediction for the modified dataset.

In one or more embodiments, the method further comprises calculating another representative statistic from the determined feature values; imputing the at least one missing data point within the at least one feature with the calculated other representative statistic from the determined feature values to create another modified dataset; and engaging the trained artificial intelligence model to generate at least one other updated prediction for the other modified dataset.

In one or more embodiments, the method further comprises generating SHAP values for features in the modified dataset based on the at least one updated prediction; generating SHAP values for features in the other modified dataset based on the at least one other updated prediction; and comparing at least one of the SHAP values for features in the modified dataset based on the at least one updated prediction to the SHAP values for features in the other modified dataset based on the at least one other updated prediction or the at least one updated prediction for the modified dataset to the at least one other updated prediction for the other modified dataset to select one of the updated prediction or the other updated prediction as a final prediction.

In one or more embodiments, the method further comprises generating SHAP values for features in the modified dataset based on the at least one updated prediction; and comparing at least one of the SHAP values for features in the dataset based on the at least one prediction to the SHAP values for features in the modified dataset based on the at least one updated prediction or the at least one prediction for the dataset to the at least one updated prediction for the modified dataset to select the updated prediction as a final prediction.

In one or more embodiments, the determined feature values include a range of feature values.

In one or more embodiments, the representative statistic includes at least one of a median of the determined feature values or a mode of the determined feature values.

In one or more embodiments, when identifying the at least one feature that requires imputation, the method comprises determining that the at least one feature includes a threshold number of missing feature values.

In one or more embodiments, the trained artificial intelligence model includes a tree-based artificial intelligence model.

According to another aspect there is provided a non-transitory computer readable storage medium comprising computer-executable instructions which, when executed, configure a processor to engage a trained artificial intelligence model to generate at least one prediction for a dataset; identify at least one feature in the dataset that requires imputation; determine feature values of the at least one feature that produced a neutral Shapley Additive exPlanation (SHAP) value; calculate a representative statistic from the determined feature values; and impute at least one missing data point within the at least one feature with the calculated representative statistic to create a modified dataset.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

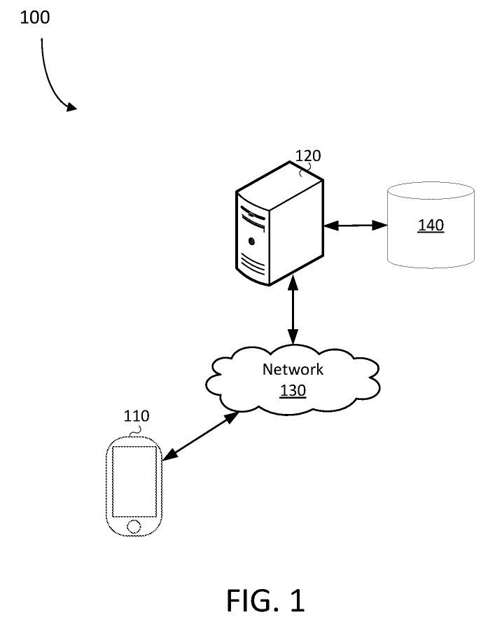

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include a database system and may maintain a database 140 that includes various data records. The data records may include one or more datasets where each dataset may include one or more features having one or more feature values. The database 140 may store at least some of the data in rows such that each row combines all features for a data point. At least some of the datasets may include incomplete or missing data and this may be due to user privacy preferences or lack of available data. At least one of the datasets may include a training dataset that may be used to train one or more artificial intelligence models to generate predictions. The training dataset may be complete in that the training dataset does not include incomplete or missing data.

The server computer system 120 may include an artificial intelligence engine that may include the one or more artificial intelligence models trained to generate predictions. As will be described in more detail, the artificial intelligence engine may include a Shapley Additive exPlanations (SHAP) analysis and imputation module to impute missing data points in an incomplete dataset.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

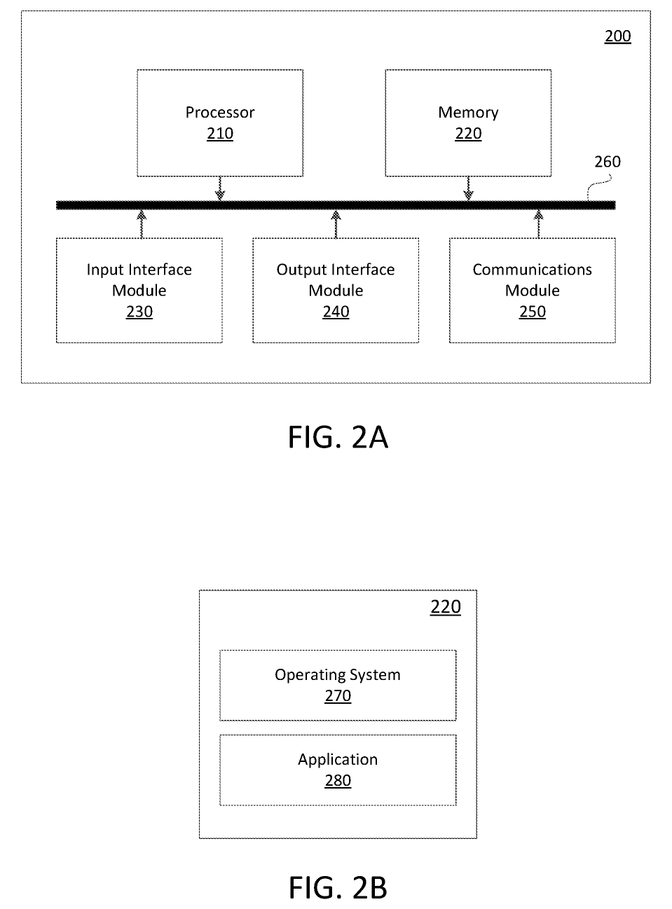

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS^{TM}, Google Android^{TM}, Linux^{TM}, Microsoft Windows^{TM}, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

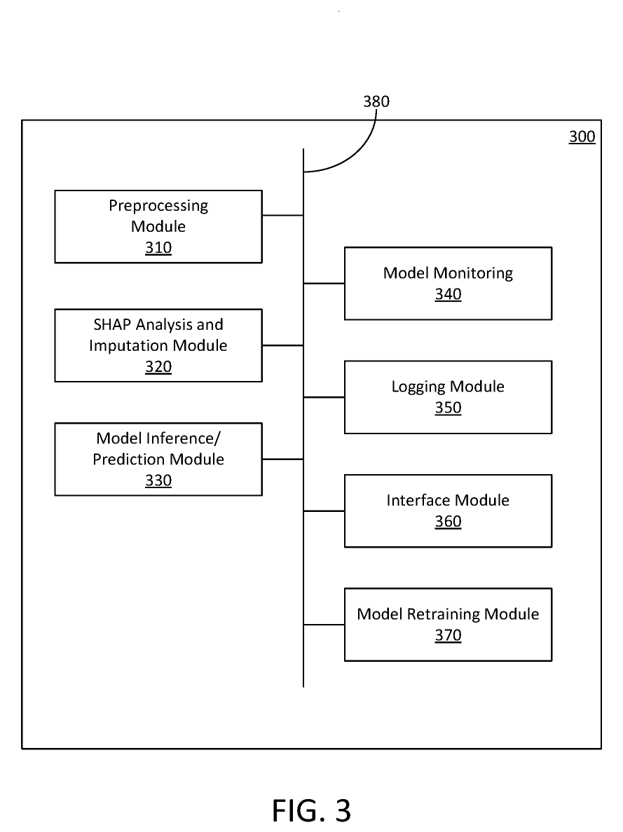

As mentioned, the artificial intelligence engine may include one or more artificial intelligence models trained to generate predictions and a SHAP analysis and imputation module to impute missing data points in an incomplete dataset. FIG. 3 is an example schematic diagram outlining various components of an artificial intelligence engine 300. As can be seen, the artificial intelligence engine 300 includes a preprocessing module 310, a SHAP analysis and imputation module 320, a model inference/prediction module 330, a model monitoring module 340, a logging module 350, an interface module 360, and a model retraining module 370. The various components communicate with one another over a pipeline 380.

The preprocessing module 310 may ingest one or more datasets and may perform operations focused on data cleaning, feature encoding, and other transformations as required. For example, the preprocessing module 310 may perform feature encoding on the one or more datasets using encoding methods such as for example one-hot encoding. The preprocessing module 310 may perform feature scaling and normalization and/or data transformation such as for example log scaling or polynomial features on the one or more datasets. The preprocessing module 310 may utilize one or more software tools such as for example a one-hot encoding software tool.

The SHAP analysis and imputation module 320 includes one or more artificial intelligence models trained to generate predictions on one or more datasets. The one or more artificial intelligence models may include tree-based models, such as Random Forests or Gradient Boosted Trees (e.g., XGBoost), as well as other types of models such as linear models, deep learning models, or ensemble models. The SHAP analysis and imputation module 320 utilizes SHAP analysis to explain the contribution of individual features to predictions generated by the one or more artificial intelligence models. The SHAP analysis and imputation module 320 avoids the need to train and validate a separate imputation model, thereby reducing development costs, minimizing system complexity, and mitigating the risk of error propagation.

By identifying features with missing data directly within the model framework, the SHAP analysis and imputation module 320 provides significant computer resource savings compared to conventional approaches that require training standalone models for imputation. The computer resource savings may include reductions in computational overhead and storage requirements since additional models need not be developed, deployed, or maintained. The streamlined integration of SHAP analysis simplifies system architecture and facilitates validation processes. Further details regarding the operations of the SHAP analysis and imputation module 320 will be described in more detail below.

The model inference/prediction module 330 may include one or more artificial intelligence models trained to generate final predictions on datasets imputed by the SHAP analysis and imputation module 320. The one or more artificial intelligence models may include the one or more artificial intelligence models trained to generate predictions. For example, the model inference/prediction module 330 may share one or more of the artificial intelligence models trained to generate predictions with the SHAP analysis and imputation module 320. Predictions generated by the model inference/prediction module 330 may include final predictions for an imputed dataset.

The model monitoring module 340 may ensure that the artificial intelligence engine 300 maintains performance and reliability over time. For example, the model monitoring module 340 may continuously monitor model performance for concept drift, may track metrics such as for example accuracy, precision, recall, and may track error or anomalies. The model monitoring module 340 may utilize one or more software tools such as for example MLflow, Prometheus, etc.

The logging module 350 may perform data logging that includes data relating to SHAP analysis and/or predictions made by the trained artificial intelligence models and this may include storing data in the database. The logging module 350 may utilize one or more software tools for data logging.

The interface module 360 may be configured to allow external systems to interact with the artificial intelligence engine 300 for data input and output. For example, the interface module 360 may provide an application programming interface (API) endpoint where external systems can send data such as for example datasets that may be fed as input to the artificial intelligence engine 300 for imputation and predictions.

The model retraining module 370 may be configured to retain the one or more artificial intelligence models periodically based on new data or when performance drops below threshold levels. The model retraining module 370 may automate retraining based on new data or performance degradation. The model retraining module 370 may monitor the artificial intelligence engine to detect retraining triggers such as when one or more performance metrics fall below threshold levels.

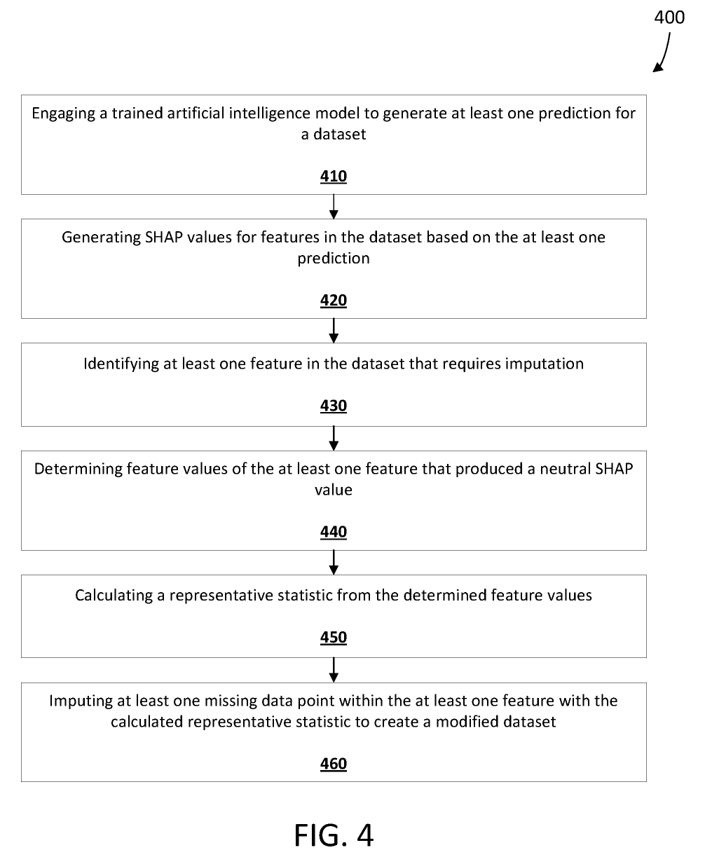

As mentioned, the artificial intelligence engine may include a SHAP analysis and imputation module to impute missing data points in an incomplete dataset. Reference is made to FIG. 4, which illustrates, in flowchart form, a method 400 for data imputation. The method 400 may be referred to as a SHAP-based imputation method. The method 400 may be implemented by a computing device having suitable processor-executable instructions for causing the computing device to carry out the described operations. The method 400 may be implemented, in whole or in part, by the server computer system 120. At least some of the operations may be performed by one or more modules of the artificial intelligence engine.

The method 400 includes engaging a trained artificial intelligence model to generate at least one prediction for a dataset (step 410).

In one or more embodiments, the server computer system 120 may engage the trained artificial intelligence module in response to receiving a request to generate the at least one prediction for the dataset. For example, a request may be received via the API endpoint provided by the server computer system 120 or may be received from the computing device 110.

In one or more embodiments, the server computer system 120 may obtain or receive the dataset. For example, the dataset may be received via the API endpoint provided by the server computer system 120. As another example, the dataset may be obtained or retrieved from the database or from another data source.

The dataset may include one or more features having one or more feature values. At least some of the data within the dataset may be arranged in rows such that each row combines all features for a data point. The dataset may be incomplete in that one or more features may be missing data. For example, one or more features may be missing data due to user privacy preferences or lack of available data.

The trained artificial intelligence model may include a tree-based artificial intelligence model that is trained to generate one or more predictions for an input dataset. The server computer system 120 engages the trained artificial intelligence module and provides the dataset as input. The trained artificial intelligence model ingests the dataset and generates at least one prediction for the dataset.

The method 400 includes generating SHAP values for features in the dataset based on the at least one prediction (step 420).

The server computer system 120 generates SHAP values for features in the dataset based on the at least one prediction output by the trained artificial intelligence model. In one or more embodiments, the SHAP analysis and imputation module may perform SHAP analysis to explain the contribution of each feature to the artificial intelligence model’s prediction. The SHAP values are calculated based on the output of the trained artificial intelligence model.

It will be appreciated that the SHAP values include SHAP values for all feature values for features for the dataset and this provides a breakdown of how individual feature values contribute to predictions across all instances.

The SHAP values may include neutral SHAP values indicating that the corresponding feature value does not have a significant contribution to the trained artificial intelligence model’s prediction. Put another way, a neutral SHAP value may reflect a lack of significant influence.

In one or more embodiments, the SHAP values may be generated using a SHAP library such as that available in Python. For example, the SHAP library may be installed. An appropriate SHAP explainer may be initialized and this may be based on the trained artificial intelligence model used to generate the prediction. Example SHAP explainers include TreeExplainer, DeppExplainer, LinearExplainer, etc.

In one or more embodiments, one or more visualization tools may be utilized such as for example Summary Plot, Force Plot, Dependence Plot, etc.

The method 400 includes identifying at least one feature in the dataset that requires imputation (step 430).

The server computer system 120 analyzes the dataset to identify at least one feature in the dataset that requires imputation. In one or more embodiments, when identifying the at least one feature in the dataset that requires imputation, the server computer system 120 may analyze the dataset to determine that the at least one feature includes a threshold number of missing feature values. The threshold number may include, for example, a single missing feature value or may include a certain number of missing feature values such as for example five (5) missing feature values. The threshold number may be defined as a percentage. For example, the threshold number may include 10% and as such any features that have 10% or more of missing feature values may be identified. As another example, the threshold number may include 90% and as such any features that have less than 90% of complete feature values may be identified.

The method 400 includes determining feature values of the at least one feature that produced a neutral SHAP value (step 440).

Responsive to identifying the at least one feature in the dataset that requires imputation, the server computer system 120 analyzes the SHAP values to determine feature values of the at least one feature that produced a neutral SHAP value. The neutral SHAP value indicates that the corresponding feature value does not have a significant contribution to the trained artificial intelligence model’s prediction. Put another way, the neutral SHAP value may reflect a lack of significant influence.

In one or more embodiments, the neutral SHAP value may include SHAP values that are close to zero (0) and this may be determined by defining that a neutral SHAP value includes a SHAP value that is within a threshold range. For example, the threshold range may include any SHAP values that are within 0.1 units of zero (plus or minus). As such, the neutral SHAP value may include SHAP values that are within a threshold range of SHAP values.

The determined feature values may include a range of feature values that all have SHAP values within the threshold range of SHAP values.

The method 400 includes calculating a representative statistic from the determined feature values (step 450).

In one or more embodiments, the representative statistic from the determined feature values may include a median of the determined feature values. As such, the server computer system 120 may calculate the median of the determined feature values.

In one or more embodiments, the representative statistic from the determined feature values may include a mode of the determined feature values. As such, the server computer system 120 may calculate the mode of the determined feature values.

The method 400 includes imputing at least one missing data point within the at least one feature with the calculated representative statistic to create a modified dataset (step 460).

The calculated representative statistic is imputed to all missing data points within the at least one feature. In this manner, the calculated representative statistic imputed to the missing data points is based on feature values known to have generated a neutral SHAP value. As such, the SHAP-based imputation method described herein leverages SHAP values to intelligently fill in missing data points ensuring that the imputed values align with feature contributions for making accurate predictions. Further, the SHAP-based imputation method described herein preserves relationships between features and minimizes impact on the model predictions.

The SHAP-based imputation method described herein increases the accuracy of model predictions. For example, models perform poorly when faced with missing data. As such, the SHAP-based imputation method described herein ensures the model can make informed and accurate predictions without biasing results and without excluding data that has one or more missing data points. Further, the SHAP-based imputation method described herein maintains relationships and dependencies between features ensuring that the imputed value(s) do not disrupt the underlying models predictions. Still further, the SHAP-based imputation method described herein eliminates the requirement of having to train a separate model to handle datasets that contain missing data points.

In one or more embodiments, the modified dataset generated by the SHAP-based imputation method described herein may be used to generate a final prediction. For example, the modified dataset may be provided as input to the trained artificial intelligence model and the resultant prediction may be defined as the final prediction.

In one or more embodiments, the modified dataset generated by the SHAP-based imputation method described herein may be used to generate an updated prediction. For example, the modified dataset may be provided as input to the trained artificial intelligence model and the resultant prediction may be defined as an updated prediction. Put another way, the server computer system 120 may engage the trained artificial intelligence model to generate at least one updated prediction for the modified dataset.

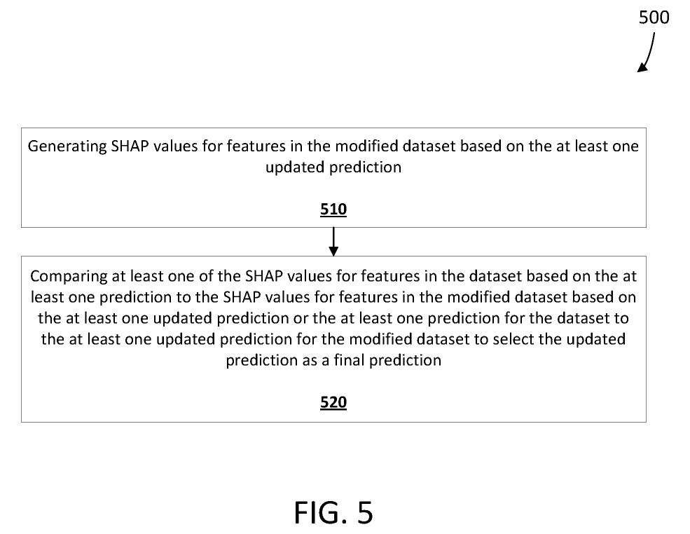

The at least one updated prediction may be analyzed to determine if it is to be selected as a final prediction. Reference is made to FIG. 5, which illustrates, in flowchart form, a method 500 for selecting the updated prediction as a final prediction. The method 500 may be implemented by a computing device having suitable processor-executable instructions for causing the computing device to carry out the described operations. The method 500 may be implemented, in whole or in part, by the server computer system 120. At least some of the operations may be performed by one or more modules of the artificial intelligence engine.

The method 500 includes generating SHAP values for features in the modified dataset based on the at least one updated prediction (step 510).

The SHAP values are generated for features in the modified dataset based on the at least one updated prediction and this may be done in manners similar to that during step 420 of the method 400 described herein.

The method 500 includes comparing at least one of the SHAP values for features in the dataset based on the at least one prediction to the SHAP values for features in the modified dataset based on the at least one updated prediction or the at least one prediction for the dataset to the at least one updated prediction for the modified dataset to select the updated prediction as a final prediction (step 520).

The SHAP values for features in the dataset based on the at least one prediction, as generated during step 420 of the method 400, may be compared to the SHAP values for features in the modified dataset based on the at least one updated prediction, as generated during step 520. Further, the at least one prediction for the dataset, as generated during step 410 of the method 400, may be compared to the at least one updated prediction for the dataset.

During the comparison, it may be determined that the updated prediction is to be used as a final prediction when it is determined that one or more model performance metrics such as accuracy are improved and this may be done using cross-validation or a hold-out test set. Further, the stability of predictions may be evaluated and a check may be performed to determine if SHAP values align with expectations, reflecting reasonable feature contributions after the imputation. When it is determined that the updated prediction has increased performance, reduced uncertainty, and/or enhanced interpretability, the updated prediction may be selected as the final prediction.

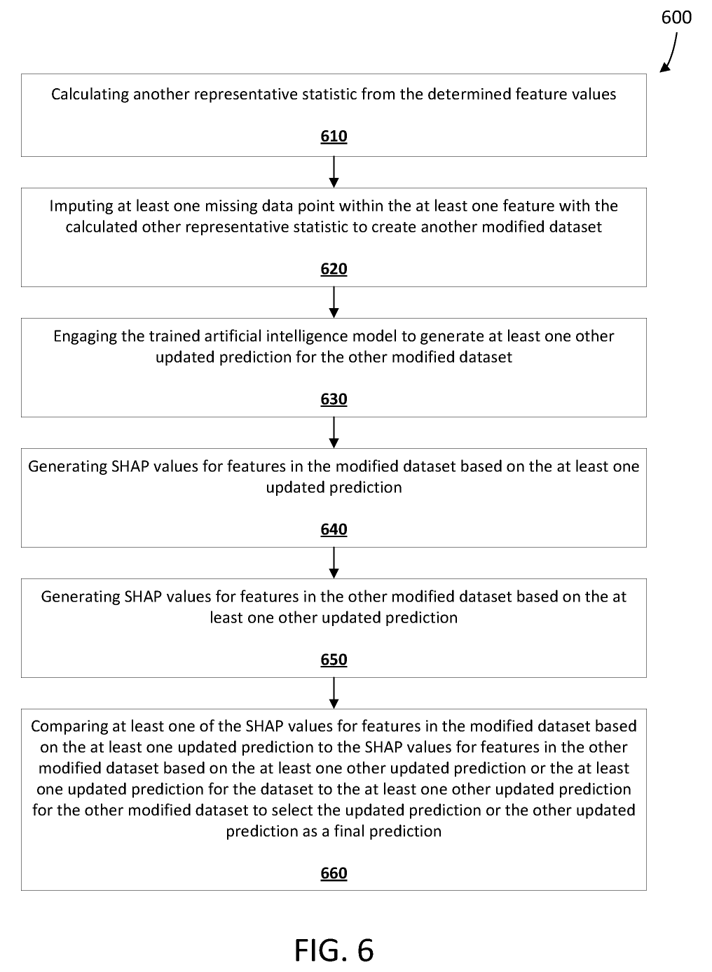

In embodiments described herein, a representative statistic such as for example median or mode is calculated from the determined feature values. In one or more embodiments, another representative statistic may be calculated and operations may be performed to determine which representative statistic is to be used to generate the final prediction. Reference is made to FIG. 6, which illustrates, in flowchart form, a method 600 for selecting a representative statistic for a final prediction. The method 600 may be implemented by a computing device having suitable processor-executable instructions for causing the computing device to carry out the described operations. The method 600 may be implemented, in whole or in part, by the server computer system 120. At least some of the operations may be performed by one or more modules of the artificial intelligence engine.

The method 600 includes calculating another representative statistic from the determined feature values (step 610).

In one or more embodiments, the other representative statistics may include a median or a mode. For example, during step 450 of the method 400 described herein, the representative statistic may include a median of the determined feature values. As such, the other representative statistic may include a mode of the determined feature values and this may be calculated by the server computer system 120.

As another example, during step 450 of the method 400 described herein, the representative statistic may include a mode of the determined feature values. As such, the other representative statistic may include a median of the determined feature values and this may be calculated by the server computer system 120.

The method 600 includes imputing the at least one missing data point within the at least one feature with the calculated other representative statistic from the determined feature values to create another modified dataset (step 620).

The imputing may be performed in manners similar to that described herein with reference to step 460 of the method 600 and in this manner, another modified dataset is created.

The method 600 includes engaging the trained artificial intelligence model to generate at least one other updated prediction for the other modified dataset (step 630).

The other modified dataset is provided as input to the trained artificial intelligence model to generate at least one other updated prediction and this may be done in manners similar to that described herein.

The method 600 includes generating SHAP values for features in the modified dataset based on the at least one updated prediction (step 640).

SHAP values are generated for features in the modified dataset based on the at least one updated prediction and this may be done in manners similar to that described herein.

The method 600 includes generating SHAP values for features in the other modified dataset based on the at least one other updated prediction (step 650).

SHAP values are generated for features in the other modified dataset based on the at least one other updated prediction and this may be done in manners similar to that described herein.

The method 600 includes comparing at least one of the SHAP values for features in the modified dataset based on the at least one updated prediction to the SHAP values for features in the other modified dataset based on the at least one other updated prediction or the at least one updated prediction for the modified dataset to the at least one other updated prediction for the other modified dataset to select one of the updated prediction or the other updated prediction as a final prediction (step 660).

The comparison may be performed to determine which statistic (median or mode), when used to impute missing data points, generates a better prediction.

During the comparison, it may be determined that the updated prediction is to be used as a final prediction or that the other updated prediction is to be used as the final prediction. For example, it may be determined that one or more model performance metrics such as accuracy are more improved when median is used as the representative statistic for the SHAP-based imputation method as compared to when mode is used as the representative statistic for the SHAP-based imputation method. When it is determined that one of the updated prediction or the other updated prediction has increased performance, reduced uncertainty, and/or enhanced interpretability, when compared with the other of the updated prediction or the other updated prediction, the prediction with the increased performance, reduced uncertainty, and/or enhanced interpretability may be selected as the final prediction.

In manners described herein, a representative statistic may be selected for the SHAP-based imputation method described herein based on a comparison of model performance. Put another way, SHAP-based imputation may be performed using two or more representative statistics and model performance may be compared to select which representative statistic results in the best model performance. Example metrics that may be compared include prediction accuracy, more consistent SHAP values, lower sensitivity, etc.

The comparison may include evaluating model performance using hold-out set or cross-validation, analyzing alignment with ground truth, assessing the consistency of the SHAP values, etc.

In one or more embodiments, training of the artificial intelligence module described herein may include selecting a particular representative statistic for the SHAP-based imputation method. The model may be selectively trained or retrained and this may be done to continuously ensure that the most accurate representative statistic is used for the SHAP-based imputation method.

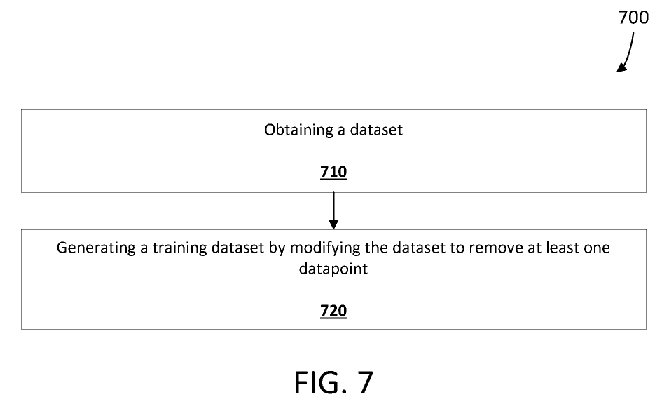

Prior to training or retraining, a training dataset may be generated. Reference is made to FIG. 7, which illustrates, in flowchart form, a method 700 for generating a training dataset The method 700 may be implemented by a computing device having suitable processor-executable instructions for causing the computing device to carry out the described operations. The method 700 may be implemented, in whole or in part, by the server computer system 120. At least some of the operations may be performed by one or more modules of the artificial intelligence engine.

The method includes obtaining a dataset (step 710).

The dataset may include one or more features having one or more feature values. The dataset may store at least some of the data in rows such that each row combines all features for a data point.

The dataset may be obtained, for example, from the database and may include features and feature values.

In one or more embodiments, the dataset may be generated using computer program code. Specifically, the computer program code may be configured to generate random feature values within defined limits for the features and may store these features and feature values in the database.

The method includes generating a training dataset by modifying the dataset to remove at least one data point (step 720).

The dataset is modified to remove or delete at least one data point. The at least one data point that is removed or deleted may include at least one feature value of at least one feature within the dataset. The number of data points that are removed may be based on rules defining how to identify features that require imputation. For example, as described herein, when identifying the at least one feature in the dataset that requires imputation, the server computer system 120 may analyze the dataset to determine that the at least one feature includes a threshold number of missing feature values. The threshold number may include, for example, a single missing feature value or may include a certain number of missing feature values such as for example five (5) missing feature values. The threshold number may be defined as a percentage. For example, the threshold number may include 10% and as such any features that have 10% or more of missing feature values may be identified. As another example, the threshold number may include 90% and as such any features that have less than 90% of complete feature values may be identified. As such, the number of data points that are removed may be based on how the server computer system 120 identifies features that require imputation. In this manner, the training data may be generated to include at least one feature that requires imputation.

The training dataset may be used to train the artificial intelligence module. For example, one or more of the methods described herein may be performed using the training set and the values used for imputation (calculated using the different representative statistics such as median and mode) may be compared to the actual (or removed) values. The comparison may be used to select which representative statistic is most accurate for the dataset.

In embodiments described herein, SHAP analysis is utilized within the model framework to explain the contribution of individual features to predictions generated by artificial intelligence models. The systems and methods described herein avoid the need to train and validate a separate imputation model, thereby reducing development costs, minimizing system complexity, and mitigating the risk of error propagation. Further, by identifying features with missing data directly within the model framework, the systems and methods described herein provide significant computer resource savings compared to conventional approaches that require training standalone models for imputation. The computer resource savings may include reductions in computational overhead and storage requirements since additional models need not be developed, deployed, or maintained. The streamlined integration of SHAP analysis simplifies system architecture and facilitates validation processes.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
a communications module;
at least one processor coupled with the communications module; and
a memory coupled to the at least one processor and storing processor-executable instructions which, when executed by the at least one processor, configure the at least one processor to:
engage a trained artificial intelligence model to generate at least one prediction for a dataset;
identify at least one feature in the dataset that requires imputation;
determine feature values of the at least one feature that produced a neutral Shapley Additive exPlanation (SHAP) value;
calculate a representative statistic from the determined feature values; and
impute at least one missing data point within the at least one feature with the calculated representative statistic to create a modified dataset.

2. The computer system of claim 1, wherein the instructions, when executed by the at least one processor, further configure the at least one processor to:
generate SHAP values for features in the dataset based on the at least one prediction.

3. The computer system of claim 1, wherein the instructions, when executed by the at least one processor, further configure the at least one processor to:
engage the trained artificial intelligence model to generate at least one updated prediction for the modified dataset.

4. The computer system of claim 3, wherein the instructions, when executed by the at least one processor, further configure the at least one processor to:
calculate another representative statistic from the determined feature values;
impute the at least one missing data point within the at least one feature with the calculated other representative statistic from the determined feature values to create another modified dataset; and
engage the trained artificial intelligence model to generate at least one other updated prediction for the other modified dataset.

5. The computer system of claim 4, wherein the instructions, when executed by the at least one processor, further configure the at least one processor to:
generate SHAP values for features in the modified dataset based on the at least one updated prediction;
generate SHAP values for features in the other modified dataset based on the at least one other updated prediction; and
compare at least one of:
the SHAP values for features in the modified dataset based on the at least one updated prediction to the SHAP values for features in the other modified dataset based on the at least one other updated prediction; or
the at least one updated prediction for the modified dataset to the at least one other updated prediction for the other modified dataset,
to select one of the updated prediction or the other updated prediction as a final prediction.

6. The computer system of claim 3, wherein the instructions, when executed by the at least one processor, further configure the at least one processor to:
generate SHAP values for features in the modified dataset based on the at least one updated prediction; and
compare at least one of:
SHAP values for features in the dataset based on the at least one prediction to the SHAP values for features in the modified dataset based on the at least one updated prediction; or
the at least one prediction for the dataset to the at least one updated prediction for the modified dataset,
to select the updated prediction as a final prediction.

7. The computer system of claim 1, wherein the determined feature values include a range of feature values.

8. The computer system of claim 1, wherein the representative statistic includes at least one of a median of the determined feature values or a mode of the determined feature values.

9. The computer system of claim 1, wherein when identifying the at least one feature in the dataset that requires imputation, the instructions, when executed by the at least one processor, further configure the at least one processor to:
determine that the at least one feature includes a threshold number of missing feature values.

10. The computer system of claim 1, wherein the trained artificial intelligence model includes a tree-based artificial intelligence model.

11. The computer system of claim 1, wherein the neutral SHAP value includes a SHAP value that is within a threshold range of SHAP values.

12. A computer-implemented method comprising:
engaging a trained artificial intelligence model to generate at least one prediction for a dataset;
identifying at least one feature in the dataset that requires imputation;
determining feature values of the at least one feature that produced a neutral Shapley Additive exPlanation (SHAP)value;
calculating a representative statistic from the determined feature values; and
imputing at least one missing data point within the at least one feature with the calculated representative statistic to create a modified dataset.

13. The computer-implemented method of claim 12, further comprising:
engaging the trained artificial intelligence model to generate at least one updated prediction for the modified dataset.

14. The computer-implemented method of claim 13, further comprising:
calculating another representative statistic from the determined feature values;
imputing the at least one missing data point within the at least one feature with the calculated other representative statistic from the determined feature values to create another modified dataset; and
engaging the trained artificial intelligence model to generate at least one other updated prediction for the other modified dataset.

15. The computer-implemented method of claim 14, further comprising:
generating SHAP values for features in the modified dataset based on the at least one updated prediction;
generating SHAP values for features in the other modified dataset based on the at least one other updated prediction; and
comparing at least one of:
the SHAP values for features in the modified dataset based on the at least one updated prediction to the SHAP values for features in the other modified dataset based on the at least one other updated prediction; or
the at least one updated prediction for the modified dataset to the at least one other updated prediction for the other modified dataset,
to select one of the updated prediction or the other updated prediction as a final prediction.

16. The computer-implemented method of claim 13, further comprising:
generating SHAP values for features in the modified dataset based on the at least one updated prediction; and
comparing at least one of:
SHAP values for features in the dataset based on the at least one prediction to the SHAP values for features in the modified dataset based on the at least one updated prediction; or
the at least one prediction for the dataset to the at least one updated prediction for the modified dataset,
to select the updated prediction as a final prediction.

17. The method of claim 12, wherein the determined feature values include a range of feature values.

18. The method of claim 12, wherein the representative statistic includes at least one of a median of the determined feature values or a mode of the determined feature values.

19. The method of claim 12, wherein when identifying the at least one feature that requires imputation, the method comprises:
determining that the at least one feature includes a threshold number of missing feature values.

20. A non-transitory computer readable storage medium comprising computer-executable instructions which, when executed, configure a processor to:
engage a trained artificial intelligence model to generate at least one prediction for a dataset;
identify at least one feature in the dataset that requires imputation;
determine feature values of the at least one feature that produced a neutral Shapley Additive exPlanation (SHAP) value;
calculate a representative statistic from the determined feature values; and
impute at least one missing data point within the at least one feature with the calculated representative statistic to create a modified dataset.
